(19) United States
(12) Patent Application Publication
(10) Pub. No.: US 2017/0032428 A1
(43) Pub. Date: Feb. 2, 2017

(54) MATCHING AND DISPLAYING ADVERTISEMENTS TO WEBSITE VISITORS

(71) Applicant: Go Daddy Operating Company, LLC, Scottsdale, AZ (US)

(72) Inventors: Paul Nicks, Marion, IA (US); Michael McLaughlin, Menlo Park, CA (US); Greg Hollingsworth, Cedar Rapids, IA (US)

(21) Appl. No.: 14/815,791

(22) Filed: Jul. 31, 2015

(51) Int. Cl. G06Q 30/02; G06F 17/30

(52) U.S. Cl. CPC G06Q 30/0277; G06F 17/30864; G06F 17/30477

(57) ABSTRACT

A registrant may register a domain name with a registrar. A domain name industry may be determined based on one or more keywords parsed from the domain name. A hosting provider may host a website (which is preferably a parked page) pointed to by the domain name. Advertisers may provide advertisements that are suitable to be displayed on a website and a corresponding advertisement geo-location and an advertisement industry for each advertisement. The hosting provider may receive the website visitor at the website and determine a visitor geo-location. The website visitor may enter a search query in a search field on the website and determine a search query industry based on parsed keywords from the search query. The hosting provider may select one or more advertisements to display to the visitor on the website by 1) comparing the domain name industry to the advertisement industries, 2) comparing the search query industry to the advertisement industries and/or 3) comparing the visitor geo-location to the advertisement geo-locations. In this manner, advertisements may be selected that most closely match the website visitor in location and industry. The hosting provider may then display the website, with the selected advertisements, to the website visitor.

### FIELD OF THE INVENTION

The present invention generally relates to the field of selecting and displaying advertisements on parked website pages. Selected advertisements are based on: 1) a domain name industry compared to advertisement industries, 2) a search query industry compared to advertisement industries and/or 3) a geo-location of a website visitor compared to advertisement geo-locations.

### SUMMARY OF THE INVENTION

The present invention provides methods for selecting and displaying one or more advertisements to a website visitor. A domain name registrant may register a domain name through a registrar. In some embodiments, a domain name industry may be determined based on one or more keywords parsed from the domain name.

A hosting provider may host a website pointed to, in a name server, by the domain name. In some embodiments, the website may be a parked page that required very little or no content from the domain name registrant and/or the website was designed and substantially all or all of the content was selected by the hosting provider.

Advertisers may provide advertisements (generally graphical images, links and/or text) that are suitable to be displayed on a website and that, when selected or clicked on, direct a website visitor to a different website operated by the advertiser. In addition to the advertisements, the advertisers may also provide a corresponding advertisement geo-location and an advertisement industry for each advertisement.

In some embodiments, the advertiser may be a hosting customer of the hosting provider. The advertiser, i.e., hosting customer, may enter hosting account information and website content as part of the hosting process. In these embodiments, the hosting provider may have access to the hosting account information and the website content of the advertiser without receiving this information as part of the advertisement process. This allows the advertiser to submit the hosting account information and website content one time as part of the hosting process while the hosting provider may determine an advertisement geo-location, an advertisement industry and other information without the advertiser having to enter this information as part of the advertisement process.

The hosting provider may receive the website visitor at a website and may determine a visitor geo-location. The geo-location may be determined, as non-limiting examples, from an IP address of the visitor, the GPS location of the visitor as determined and communicated by a mobile device or a geo-location entered or selected by the visitor.

In some embodiments, the visitor may enter a search query in a search field on the website designed for this purpose. The hosting provider may determine a search query industry based on the parsed keywords from the search query.

The hosting provider may select one or more advertisements to display to the visitor on the website. In selecting the one or more advertisements the hosting provider may 1) compare the domain name industry to the advertisement industries of the advertisements, 2) compare the search query industry to the advertisement industries of the advertisements and/or 3) compare the visitor geo-location to the advertisement geo-locations of the advertisements. In this manner, advertisements may be selected that most closely match the website visitor.

One, two or three of the comparisons may be used and, if desired, different weights may be given to each comparison as part of the selection process. In addition, other factors, such has how often each advertisement has been used and/or if an additional advertisement fee was paid for an advertisement, may be used to select which advertisements are displayed on the website to the website visitor.

The hosting provider may then display the website, with the selected advertisements, to the website visitor.

When an advertisement of an advertiser is displayed on a first website and selected by a website visitor, the website visitor may be directed to a second website operated by the advertiser. An advertisement fee collected from the advertiser may then, in some embodiments, be all or partially disbursed to the domain name registrant.

The above features and advantages of the present invention will be better understood from the following detailed description taken in conjunction with the accompanying drawings.

### BRIEF DESCRIPTION OF THE DRAWINGS

FIG. 1 is a block diagram of a system that may be used to select and display advertisements on parked website pages based on a domain name industry, identified by keywords in a domain name used to visit the website, compared to advertisement industries, a search query industry, identified by keywords in an entered search query, compared to advertisement industries and/or a geo-location of a website visitor compared to advertisement geo-locations.

FIG. 2 is a block diagram of a system that may be used to select and display advertisements on parked website pages based on a domain name industry, identified by keywords in a domain name used to visit the website, compared to advertisement industries, a search query industry, identified by keywords in an entered search query, compared to advertisement industries and/or a geo-location of a website visitor compared to advertisement geo-locations.

FIGS. 3-5 are a flow diagram of a method for selecting and displaying advertisements on parked website pages based on: 1) a domain name industry, identified by keywords in a domain name used to visit the website, compared to advertisement industries, 2) a search query industry, identified by keywords in an entered search query, compared to advertisement industries and/or 3) a geo-location of a website visitor compared to advertisement geo-locations.

FIGS. 6 and 7 are a flow diagram of a method for a hosting provider to receive advertisements from a hosting customer and place those advertisements on other websites, preferably when the other websites are parked pages.

FIGS. 8 and 9 are a flow diagram of another method for a hosting provider to receive advertisements from a hosting customer and place those advertisements on other websites, preferably when the other websites are parked pages.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

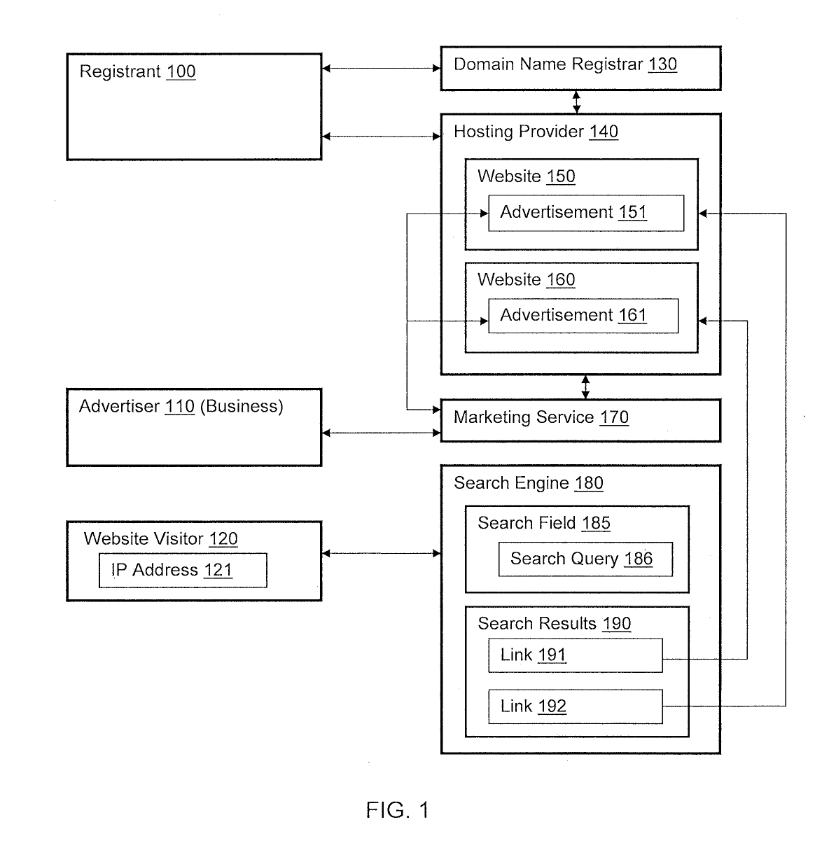

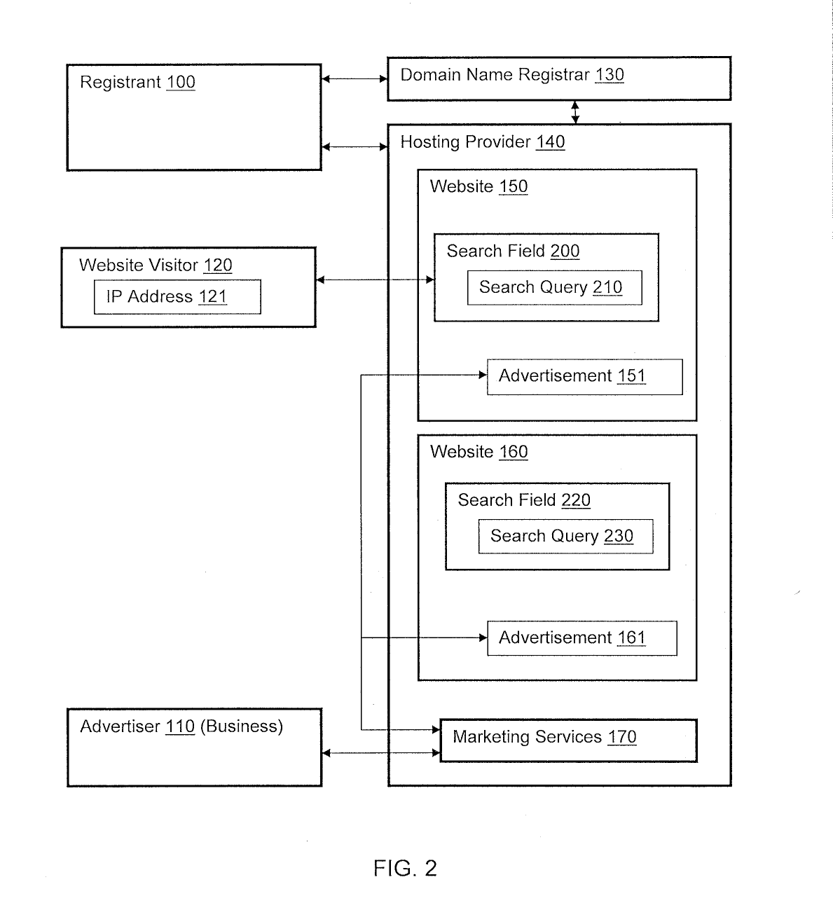

FIGS. 1 and 2 are block diagrams of a system that may be used to practice the present invention. The arrows and boxes may represent computer networks and boxes within boxes may also communicate with each other by computer networks. A computer network is a collection of links and nodes (e.g., multiple computers and/or other devices connected together) arranged so that information may be passed from one part of the computer network to another over multiple links and through various nodes. Non-limiting examples of computer networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow for the easy and robust exchange of information between website visitors 120 with computers and/or websites 150, 160. While only one registrant 100, one domain name registrar 130, one advertiser 110, one website visitor 120, one hosting provider 140, one marketing service 170 and one search engine are illustrated to avoid obscuring the invention, a plurality of registrants, domain name registrars, advertisers, website visitors, hosting providers, marketing services and search engines may be used to practice the invention and communicate with each other over the Internet.

Operators of websites 150, 160 may place content, such as multimedia information (e.g., text, graphics, audio, video, animation, and other forms of data) and advertisements 151, 161 at specific locations on the Internet referred to as websites 150, 160. The combination of all the websites 150, 160 and their corresponding web pages on the Internet is generally known as the World Wide Web (WWW) or simply the Web.

For individuals and businesses alike, the Internet continues to be increasingly valuable. People use the Web for everyday tasks, from social networking, shopping, banking, and paying bills to consuming media and entertainment. E-commerce is growing, with businesses delivering more services and content across the Internet, communicating and collaborating online, advertising products and services (even products and services of third parties) and inventing new ways to connect with each other.

Prevalent on the Web are websites 150, 160 that may offer and sell goods and services to individuals and organizations or provide information. Websites 150, 160 may consist of a single webpage, but typically consist of multiple interconnected and related webpages. Websites 150, 160 unless very large and complex or have unusual traffic demands, may reside on a single server and are prepared, maintained and/or operated by a single individual or entity (although websites 150, 160 residing on multiple servers are also common). Menus, links, tabs, etc. may be used by people to move between different web pages within a website 150, 160 or to move to a different website 150, 160.

Websites 150, 160 may be created using HyperText Markup Language (HTML) to generate a standard set of tags that define how the webpages for the website 150, 160 are to be displayed. Website visitors 120 using the Internet may access content providers' websites using software known as an Internet browser, such as MICROSOFT INTERNET EXPLORER, GOOGLE CHROME or MOZILLA FIREFOX. After the browser has located the desired webpage, the browser requests and receives information from the webpage, typically in the form of an HTML document, and then displays the webpage content for the person accessing the Internet. The website visitors 120 may view other webpages at the same website 150, 160 or move to an entirely different website 150, 160 using their browser.

Hosting providers 140 may provide the hardware, software, and electronic communication means necessary to connect multiple websites 150, 160 to the Internet. A single hosting provider 140 may literally host thousands of websites 150, 160 on one or more servers. The servers may be, as a non-limiting example, one or more Dell PowerEdge(s) rack server(s), HP Blade Servers, IBM Rack or Tower servers, although other types of servers and/or combinations of one or more servers may also be used.

A hosting provider 140 is hereby defined to be a machine, comprising at least one or more physical computers/servers, physical routers, cables, microprocessors or microcontrollers and computer memory. While the hosting provider 140 preferably includes software to automate the process of hosting websites 150, 160 for a plurality of domain name registrants 100, the hosting provider 140 cannot be just, merely or only software and the hosting provider 140 must be interpreted and is hereby defined to meet the definition of a machine.

Browsers are able to locate specific websites 150, 160 because each website 150, 160, resource and computer on the Internet has a unique Internet Protocol (IP) address. The browser (operated by a person) may use the Domain Name System (DNS) to obtain the IP address of a domain name or a URL. As an example, the browser may contact the DNS with an initial domain name or URL and the DNS may allow the name server to respond with an initial IP address associated with the initial domain name. In this way browsers are able to find IP addresses for domain names and URLs.

The DNS is a hierarchical distributed naming system for computers, services, or any resource connected to the Internet or a private network. The DNS associates various information with domain names and URLs. Most prominently, the DNS translates easily memorized domain names to the numerical IP addresses needed for the purpose of locating computer services and devices worldwide on the Internet.

The DNS distributes the responsibility of assigning domain names and mapping those domain names to IP addresses by designating authoritative name servers for each domain. Authoritative name servers are assigned to be responsible for their supported domains, and may delegate authority over subdomains to other name servers. This mechanism provides a distributed and fault tolerant service and is designed to avoid the need for a single central database.

Name servers may be thought of as acting like telephone books, i.e., name servers translate domain names into IP addresses much like a telephone book can translate a name into a telephone number. A name server or a plurality of name servers may be used to practice the invention.

Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A URL is much easier to remember and may be used to point to any computer, directory, or file on the Internet. A browser is able to access a website 150, 160 on the Internet through the use of a URL. The URL may include a Hypertext Transfer Protocol (HTTP) request combined with the website's Internet address, also known as the website's domain name. An example of a URL with an HTTP request and domain name is: http://www.companyname.com. In this example, the “http” identifies the URL as a HTTP request and the “companyname.com” is the domain name. The “companyname” portion may be referred to as a second-level domain and the “.com” may be referred to as a top-level domain.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the Registry is also the authoritative source for contact information related to the domain name and is referred to as a “thick” Registry. For other TLDs (e.g., .com and .net) only the domain name, registrar 130 identification, and name server information are stored within the Registry, and a registrar 130 is the authoritative source for the contact information related to the domain name. Such Registries are referred to as “thin” registries. Most gTLDs are organized through a central domain name Shared Registration System (SRS) based on their TLD.

A registrar 130, also known as a domain name registrar 130, is hereby defined to be a machine, comprising at least one or more physical computers/servers, hardware routers, cables, microprocessors or microcontrollers and computer memory. While the registrar 130 preferably includes software to automate at least the process of registering one or more domain names to a plurality of registrants 100, the registrar 130 cannot be just, merely or only software and must be interpreted and is hereby defined to meet the definition of a machine.

The process for registering a domain name with .com, .net, .org, and some other TLDs allows a registrant 100 to use an ICANN-accredited registrar 130 to register a domain name. The registrar 130 may use a plurality of servers to perform its functions. If a registrant 100 wishes to register the domain name mycompany.com, the registrant 100 may initially determine whether the desired domain name is available by contacting a domain name registrar 130. The registrant 100 may make this contact using the Registrar's webpage and typing the desired domain name into a field on the registrar's webpage created for this purpose. Upon receiving the request from the registrant 100, the registrar 130 may ascertain whether mycompany.com has already been registered by checking the SRS database associated with the TLD of the domain name, by checking with the registry or by any other now known or later developed method. The results of the search may then be displayed on the webpage to thereby notify the registrant 100 of the availability of the domain name. If the domain name is available, the registrant 100 may proceed with the registration process. If the domain name is not available for registration, the registrant 100 may keep selecting alternative domain names until an available domain name is found. A registrant 100 that registers a domain name is known as the registrant 100 of the domain name. A single entity may be both a registrar 130 and a hosting provider 140 or the functionality may be spread across two or more entities.

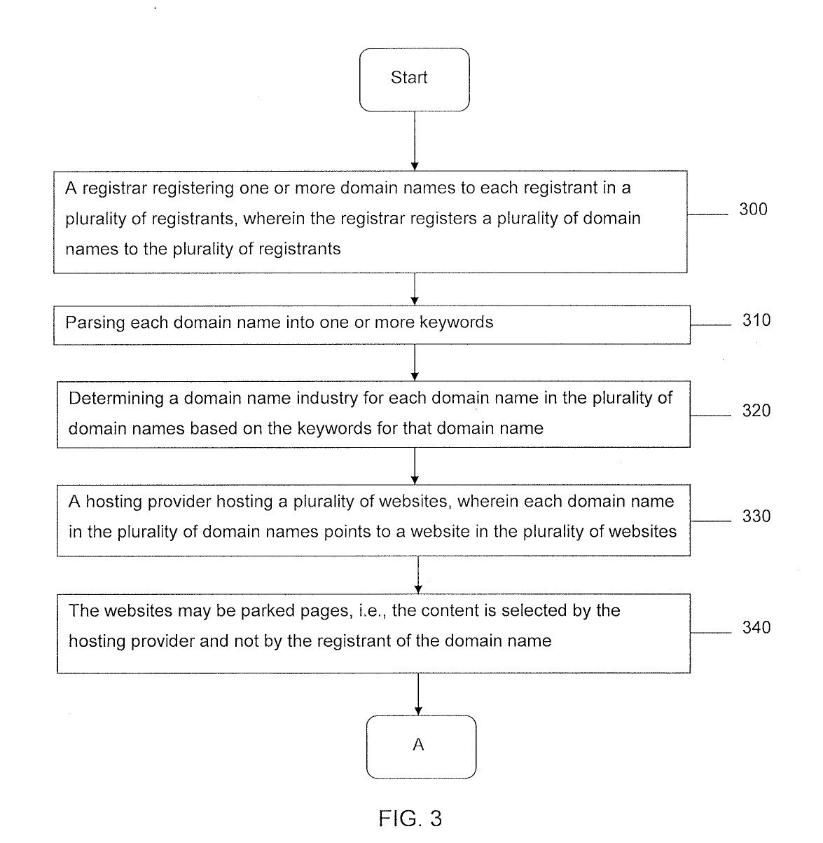

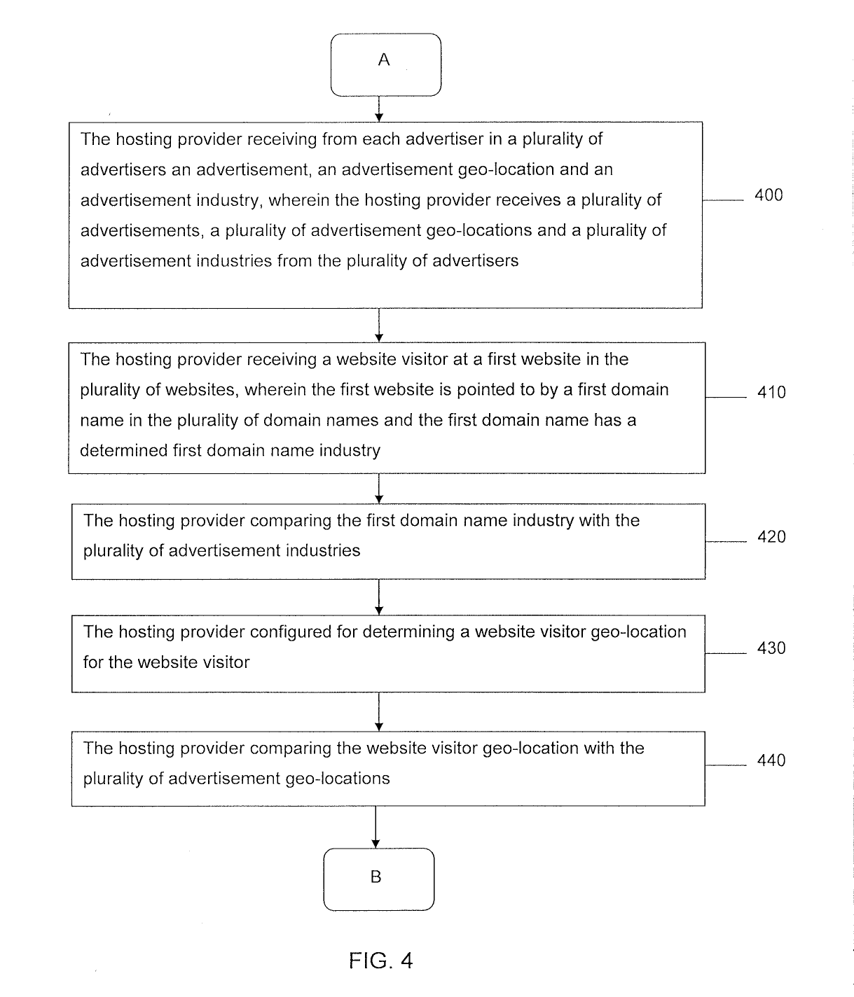

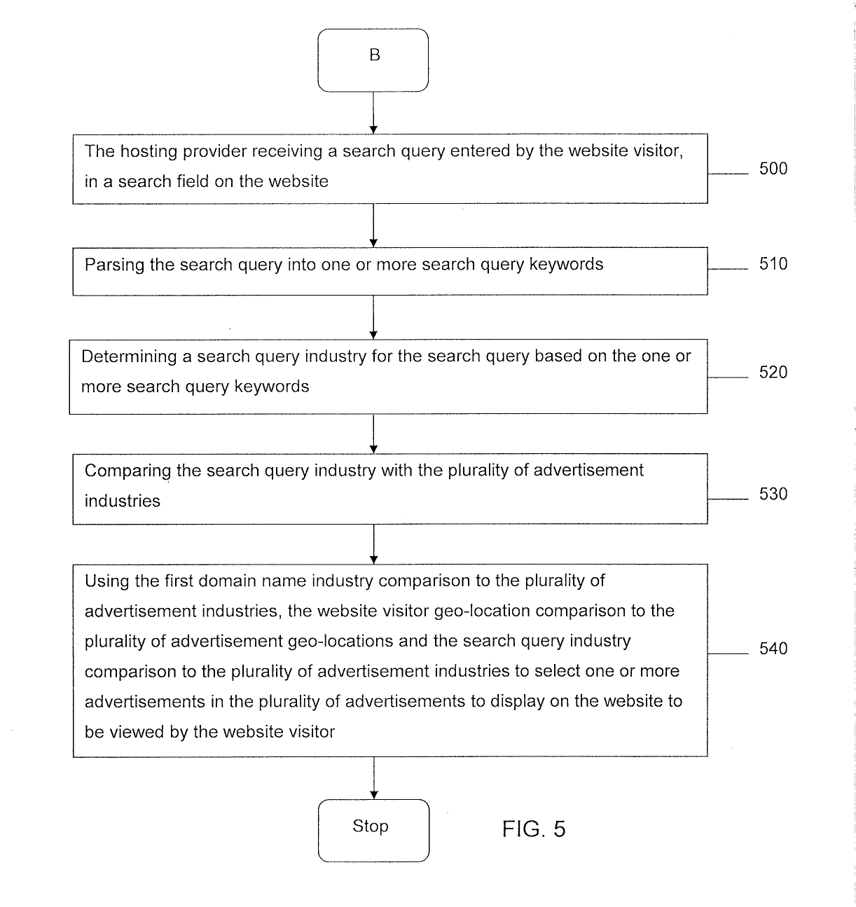

FIGS. 1 and 2 illustrate example systems and FIGS. 3-5 illustrate an example method of practicing the invention. A registrar 130 may register one or more domain names to a plurality of registrants 100. The registrar 130 may thus register a plurality of domain names to the plurality of registrants 100. (Step 300) Each registrant 100 may manage the registrant's domain names from an account with the registrar 130. The registrar 130 may require the account name and password (or other methods of identifying or authenticating the registrant 100) from the registrant 100 to control the one or more registered domain names.

The registrar 130, a hosting provider 140 or other entity may parse each domain name into one or more keywords or tokens. (Step 310) As an example, the domain name newyorkpizza.com may be parsed into “New York” and “pizza,” the domain name “fastcarrepair.com” may be parsed into “fast,” “car” and “repair” and greatshoes.com may be parsed into “great” and “shoes.”

The registrar 130, hosting provider 140 or other entity may determine a domain name industry for one or more of the registered domain names based on the keywords for that domain name. (Step 320) As examples, the keywords “New York” and “pizza” may be determined to be either an Italian New York domain name industry or a fast food New York domain name industry, the keywords “fast,” “car” and “repair” may be determined to be in an automobile repair domain name industry and “great” and “shoes” may be determined to be in the clothing or shoe domain name industry.

A hosting provider 140 may host a plurality of websites 150, 160, wherein each website 150, 160 may have one or more webpages. Each of the registered domain names may point to a website 150, 160 in the plurality of websites 150, 160. (Step 330)

In some embodiments, the registrant 100 may design and select the content for a website 150, 160 pointed to by a domain name registered to the registrant 100. In other embodiments, the hosting provider 140 may design and select the content for a website 150, 160 pointed to by a domain name registered to a registrant 100. Websites 150, 160 designed and selected by a hosting provider 140 may be referred to as parked pages and the registrant 100 may not have designed nor selected any of the content for this type of website 150, 160. Websites 150, 160 entirely designed and content selected by the hosting provider 140 are very easy for the registrant 100 as the registrant 100 only has to register the domain name pointing to the website 150, 160 (parked page). (Step 340)

In some embodiments, the registrant 100 may specifically request that one or more of the domain names registered to the registrant 100 be pointed to, in a name server, a website 150, 160 that is designed and the content selected by the hosting provider 140. In other embodiments, the hosting provider 140 may automatically or by default unless directed otherwise, to create a website 150, 160 (also known as a parked page) for domain names that are not being used, i.e., domain names that are not already pointing to a website 150, 160. This allows the hosting provider 140 and/or registrant 100 to receive advertisement fees from the advertiser 110 for domain name traffic to domain names that are not otherwise being used.

The hosting provider 140 or a marketing service 170 working with the hosting provider 140 may receive from an advertiser 110 an advertisement 151, 161, an advertisement geo-location and an advertisement industry. The advertisement 151, 161 may be a graphical image, picture and/or text that advertises a product or service. In preferred embodiments, website visitors 120 that see the advertisement 151, 161 on a first website 150, 160 may click on the advertisement 151, 161 and be directed to a second website 150, 160 operated by the advertiser 110.

The advertisement geo-location is preferably the geographical area that the advertiser 110 desires to sell products and/or provide services. The world may be divided into different geo-locations that may be selected by the advertisers 110. Advertisements 151, 161 may have, as non-limiting examples, a world wide geo-location, a country wide geo-location, a regional geo-location, a state geo-location or a town/city geo-location. As specific non-limiting examples, an advertisement 151, 161 may have a advertisement geo-location of the world, United States, Arizona or Phoenix.

The categories of possible website visitor geo-locations are preferably selected to either match or be subsets of the categories of possible advertisement geo-locations to make it easier to select appropriate advertisements 151, 161 for each website visitor 120. Specifically, an advertisement 151, 161 with an advertisement geo-location that matches or overlaps a website visitor geo-location would be given preference and be more likely to be displayed than an advertisement 151, 161 with an advertisement geo-location that did not match or did not overlap the website visitor geo-location.

The advertisement industry is preferably the industry related to a product or a service to be advertised in the advertisement 151, 161 submitted by the advertiser 110. Various industries may be determined and allowed to be selected by the advertiser 110 as an advertisement industry. As non-limiting examples, the advertisement industry may be fast foods, automobile repair or shoe industry. Any number of different advertisement industries may be used in practicing the invention.

In preferred embodiments, the domain name industries that may be determined for a domain name are the same as the advertisement industries that may be selected by an advertiser 110. In other words, the possible categories are preferably made to be the same. It is easier to match a domain name industry with an advertisement industry when the list of possible domain name industries is the same as the list of possible advertisement industries.

The hosting provider 140 may receive additional advertisements 151, 161, advertisement geo-locations and advertisement industries from the same advertiser 110 or from additional advertisers. The hosting provider 140 may over time receive a plurality of advertisements 151, 161, a plurality of advertisement geo-locations and a plurality of advertisement industries from a plurality of advertisers 110. (Step 400)

FIG. 1 illustrates a system where the website visitor 120 may start at a search engine website 180, such as, as non-limiting examples, GOOGLE.COM or BING.COM. The website visitor 120 may enter a search query 186 in a search field 185 created for this purpose. The search engine website 180 may create a search result 190 that includes links 191, 192. The website visitor 120 may select a link 191, 192 and be directed to a website 150, 160 on hosting provider 140 that may display advertisements 151, 161 to the website visitor 120.

FIG. 2 illustrates a system where the hosting provider 140 may receive a website visitor 120 at a first website 150, 160 in a plurality of websites 150, 160. A first domain name may point, in a name server, to the first website 150, 160. In some embodiments, the first domain name may have a determined first domain name industry, although this is not required in all embodiments. (Step 410)

The hosting provider 140, in some embodiments, may compare the first domain name industry with the plurality of advertisement industries. (Step 420) In this manner, the hosting provider 140 may determine which, if any, advertisements 151, 161 have an advertisement industry that matches, overlaps, is similar to and/or is closer than any other advertisement, the domain name industry. Since the website visitor 120 entered or selected the domain name, the website visitor 120 may be interested in the determined domain name industry and so may also be interested in advertisements 151, 161 that have a matching, overlapping, similar, and/or closer than any other advertisement industry.

The hosting provider 140 may determine a website visitor geo-location for the website visitor 120. (Step 430) Any method of determining the geo-location of the website visitor 120 may be used. As non-limiting examples, the geo-location of the website visitor 120 may be determined using a known location of the IP address 121 the website visitor 120 used to visit the website 150, 160, a GPS location supplied by the website visitor's client (such as a smart phone) or a geo-location entered by the website visitor 120.

The hosting provider 140 may compare the website visitor geo-location with the plurality of advertisement geo-locations. (Step 440) Any method of comparing the website visitor geo-locations with the plurality of advertisement geo-locations may be used. Advertisements 151, 161 with advertisement geo-locations that match or overlap the website visitor geo-locations are preferably given preference for displaying to the website visitor 120 over advertisements 151, 161 with advertisement geo-locations that do not match or do not overlap the website visitor geo-location.

In some embodiments, the hosting provider 140 may receive a search query 210, 230 entered by the website visitor 120, in a search field 200, 220 on the website 150, 160. (Step 500) The search query 210 may be parsed into one or more search query keywords (keywords may be actually words as determined from an electronic dictionary or a combination of words that are known to commonly go together). (Step 510) Words that are articles of speech, are very commonly used and/or do not add much or any meaning may be dropped. As an example, the website visitor 120 may enter the search query of “shoes in New York.” The hosting provider 140 may parse the search query of “shoes in New York” into the keywords of “shoes” and “New York.”

A search query industry may be determined for the search query based on the one or more search query keywords. (Step 520) As an example, if the keywords are “shoes” and “New York” then the search query industry may be assigned “shoes” or “New York shoes.” The search query industry may be determined by any desired method. As non-limiting examples, the search query industry may be found by finding an industry that most closely matches the keywords in the search query, using an artificial intelligence or learning software to determine the industry most likely interested in by the website visitor 120 based on the entered search query or by using past website visitor's (the same website visitor 120 or a different website visitor) actions when presented with different advertisements 151, 161.

In some embodiments, the website visitor geo-location may also be determined or be based on the keywords parsed from the search query entered by the website visitor 120.

In some embodiments, the search query industry may be compared with the plurality of advertisement industries. (Step 530) Any method of comparing the search query industry with the plurality of advertisement industries may be used. Advertisements 151, 161 with advertisement industries that match or overlap the search query industry are preferably given preference for displaying to the website visitor 120 over advertisements 151, 161 with advertisement industries that do not match or do not overlap the search query industry.

Many other factors may be used and considered in selecting one or more advertisements 151, 161 from the plurality of advertisements 151, 161 received from the plurality of advertisers 110 to display on the website 150, 160 to be viewed by the website visitor 120.

One factor that may be used and considered automatically without human intervention and programmatically by the hosting provider 140 is to determine how closely the domain name industry (determined from the domain name entered by the website visitor 120) matches or overlaps with each advertisement industry in the plurality of advertisement industries. In some embodiments, the closer the match of the domain name industry with an advertisement industry, the greater the preference for displaying the corresponding advertisement 151, 161.

Another factor that may be used and considered automatically without human intervention and programmatically by the hosting provider 140 in selecting one or more advertisements 151, 161 to display on the website 150, 160 to be viewed by the website visitor 120 is to determine how closely the website visitor geo-location matches or overlaps with each advertisement geo-location in the plurality of advertisement geo-locations. In some embodiments, the closer the match of the website visitor geo-location with an advertisement geo-location, the greater the preference for displaying the corresponding advertisement 151, 161.

Another factor that may be used and considered automatically without human intervention and programmatically by the hosting provider 140 in selecting one or more advertisements 151, 161 to display on the website 150, 160 to the website visitor 120 is how closely the search query industry matches or overlaps with each advertisement industry in the plurality of advertisement industries. In some embodiments, the closer the match of the search query industry with an advertisement industry, the greater the preference for displaying the corresponding advertisement 151, 161.

Another factor that may be used and considered automatically without human intervention and programmatically by the hosting provider 140 in selecting one or more advertisements 151, 161 to display on the website 150, 160 to the website visitor 120 is to determine how when the advertisements were last displayed. Advertisements 151, 161 that have not been recently displayed may be given preference over advertisements 151, 161 that have been recently displayed. The hosting provider 140 may rotate the advertisements 151, 161 so that the advertisements 151, 161 that have not been recently displayed are given preference over advertisements 151, 161 that have been recently displayed.

Another factor that may be used and considered automatically without human intervention and programmatically by the hosting provider 140 in selecting one or more advertisements to display on the website 150, 160 to the website visitor 120 is how much was the advertising fee for each advertisement. Preference may be given to advertisements with or with a higher advertisement fee over advertisements without or with a lower advertising fee.

Another factor that may be used and considered automatically without human intervention and programmatically by the hosting provider 140 is whether the advertiser is a hosting customer of the hosting provider 140. Advertisements from advertisers that are hosting customers of the hosting provider 140 may be given preference over advertisements from advertisers that are not hosting customers of the hosting provider 140.

The hosting provider 140 may use one or more of these factors to select one or more advertisements 151, 161 in the plurality of advertisements 151, 161 to display on the website 150, 160 to be viewed by the website visitor 120. (Step 540) One or more of the factors may be used to give a preference to a first one or more advertisements over a second one or more advertisements that are not given a preference. The factors may be weighted, such that some factors (those given a greater weight) may have a greater impact on which advertisement(s) 151, 161 are selected over other factors that are given a lower weight. Based on one or more of the above factors, a preference may be given by the hosting provider 140 to one or more advertisements 151, 161 in a plurality of advertisements. In some embodiments, an advertisement 151, 161 with a preference may be displayed more prominently or instead of a similar advertisement without a preference, while in other embodiments a preference is only one factor out of many factors that are considered in selecting an advertisement 151, 161 for display on the website 150, 160 to the website visitor 120.

In some embodiments, advertisements 151, 161 may be ranked based on the website visitor geo-location, the website visitor industry, the advertisement geo-location and the advertisement industry.

The hosting provider 140 may then display the website 150, 160, with the selected advertisement(s) 151, 161, to the website visitor 120.

In some embodiments, the advertiser 110 may pay a fee to the hosting provider 140 and/or to the registrant 100 for every advertisement 151, 161 displayed on the website 150, 160 to the website visitor 120, every advertisement 151, 161 clicked on by the website visitor 120 and/or based on products and/or services purchased by the website visitor 120 from the advertiser 110 from either the website 150, 160 on the hosting provider 140 or from a different website operated by the advertiser 110.

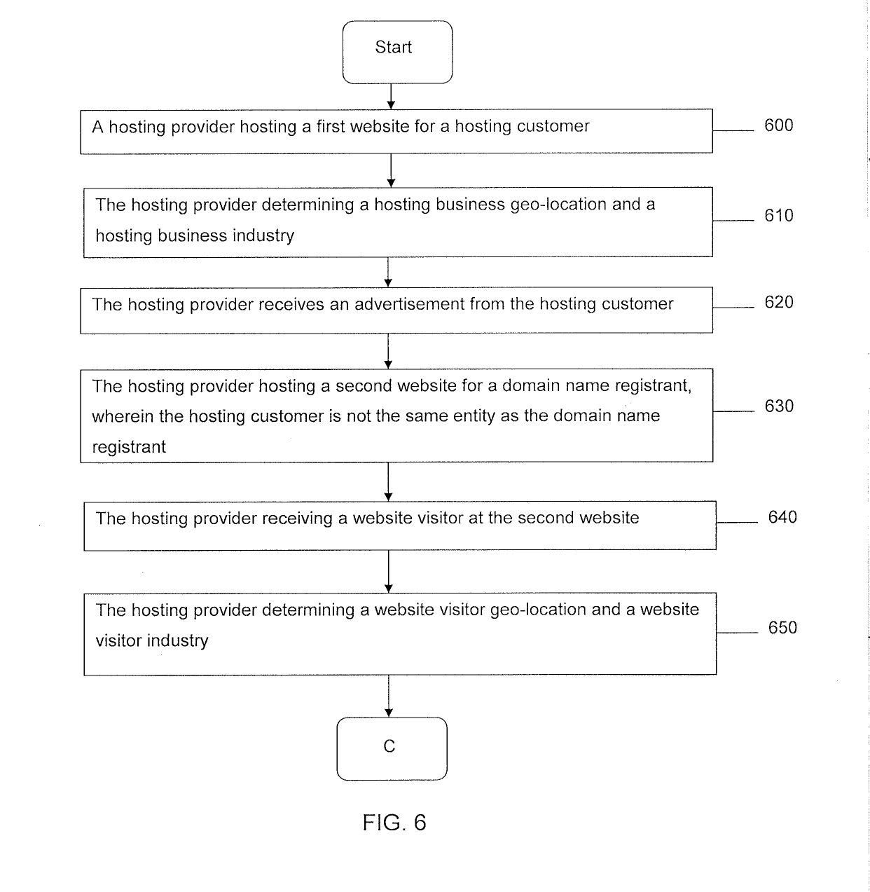

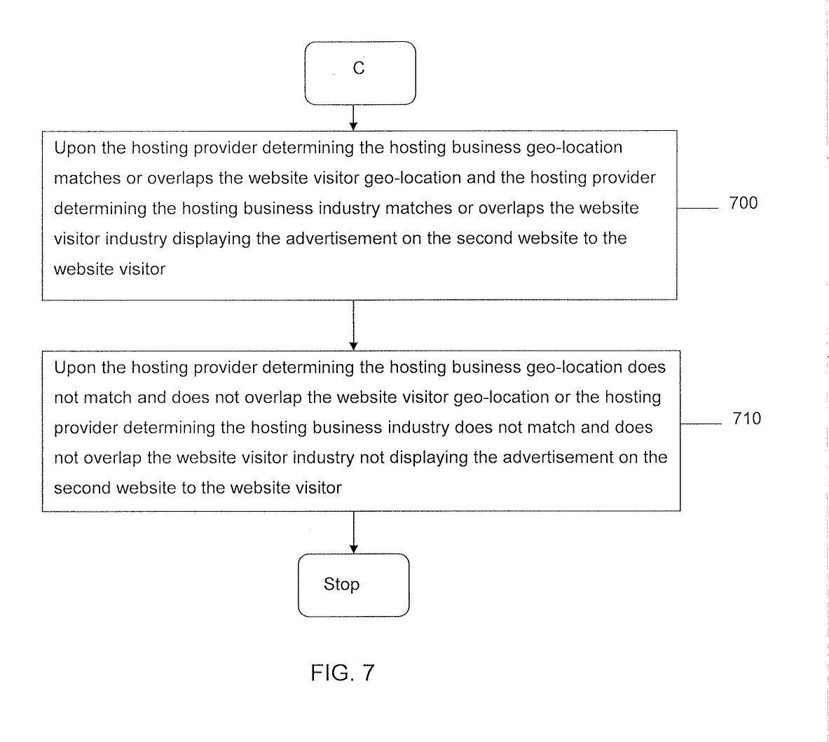

Another embodiment will be described with reference to FIGS. 6 and 7. A hosting provider 140 may host a first website for a hosting customer. (Step 600) The hosting provider 140 may determine a hosting business geo-location and a hosting business industry. (Step 610) The hosting business geo-location and the hosting business industry may be determined from customer entered data or from data collected from the first website (such as from text that is displayed on the first website). The hosting business geo-location may be or be used to determine an advertisement geo-location for any advertisements from the hosting customer. The hosting business industry may be or be used to determine an advertisement industry for any advertisements from the hosting customer.

The advertiser 110 may be a hosting customer of the hosting provider 140. The advertiser 110, i.e., hosting customer, may enter hosting account information and website content as part of the hosting process for hosting a website of the advertiser 110. The hosting provider 140 may have access to the hosting account information and the website content of the advertiser without receiving this information as part of the advertisement process. This allows the advertiser 110 to submit the hosting account information and website content one time as part of the hosting process for the advertiser's website so the hosting provider 140 may determine an advertisement geo-location, an advertisement industry and other information without the advertiser 110 having to enter this information as part of the advertisement process.

As a non-limiting example, an advertiser 110 may be a hosting customer of a hosting provider 140. The advertiser 110 may enter hosting account information and website content that the hosting provider 140 may receive as part of the hosting process. The advertiser 110 may submit an advertisement, preferably an image with a link to a website operated by the advertiser 110, but not submit an advertisement geo-location and/or an advertisement industry as part of the advertisement process. The hosting provider 140 may parse, i.e., analyze, the hosting account information and/or the website content of the website of the advertiser 110 to determine the advertisement geo-location, the advertisement industry and/or one or more keywords. The one or more keywords may be used as additional advertisement geo-locations and/or additional advertisement industries.

As a non-limiting example, a hosting provider 140 may parse a website content of a website (or hosting account information) of the advertiser 110 (who is also a hosting customer) and determine an address of a business, such as “Sunnyvale, Calif.,” operated by the advertiser 110. The address of the business may then be used to determine an advertisement geo-location for any and/or all submitted ads by the advertiser 110, even if the advertiser 100 did not submit the advertisement geo-location as part of the advertisement process. Alternatively, any addresses in the website content or the hosting account information may be used as keywords to match with the domain name geo-location, search query geo-location or any other aspect of the website visitor 120. One or more matches of keywords may be used as another positive factor in selecting which advertisements are displayed to the website visitor 120.

As another non-limiting example, the hosting provider 140 may parse the website content of the website (or hosting account information) of the advertiser 110 (who is also the hosting customer) and determine a menu of the business operated by the advertiser 110. The menu items, such as “veal picatta,” may then be used to determine one or more advertisement industries for any and/or all submitted advertisements by the advertiser 110, even if the advertiser 110 did not submit the advertisement industry as part of the advertisement process. Alternatively, any industries (even determined by menu items) in the website content or the hosting account information may be used as keywords to match with the domain name industry, the search query industry or any other aspect of the website visitor 120. One or more matches of keywords may be used as another positive factor in selecting which advertisements are displayed to the website visitor 120.

Parsing hosting account information and/or website content of an advertiser 110 to determine additional advertisement geo-locations, additional advertisement industries or keywords that may be matched to a website visitor 120 may be performed when the advertiser 110 does not submit an advertisement geo-location and/or an advertisement industry or when the advertiser 110 does submit an advertisement geo-location and/or an advertisement industry.

The hosting provider 140 may receive one or more advertisements 151, 161 from the hosting customer. (Step 620) Any number of advertisements 151, 161 may be received by the hosting provider from a plurality of hosting customers.

The hosting provider 140 may host a second website for a domain name registrant. The hosting customer and the domain name registrant are preferably not the same person or entity. (Step 630)

The hosting provider 140 may receive a website visitor 120 to the second website. The first website is not the same website as the second website. In preferred embodiments, the second website is a parked page, i.e., a website that is not being used by the domain name registrant of the domain name pointing, in a name server, to the website. (Step 640)

The hosting provider 140 may determine a website visitor geo-location and a website visitor industry for the website visitor 120. The website visitor geo-location may be determined using any desired method. As non-limiting examples, the IP address or GPS location of the website visitor 120 may be determined.

The website visitor industry may be determined using any desired method. As non-limiting examples, the domain name of the second website used by the website visitor 120 may be parsed to find keywords that may be used to determine a website visitor industry or a history associated with the website visitor 120 may be used to determine a website visitor industry. (Step 650)

Upon the hosting provider 140 determining the hosting business geo-location matches or overlaps the website visitor geo-location and the hosting provider determining the hosting business industry matches or overlaps the website visitor industry, the hosting provider 140 may display the advertisement on the second website to the website visitor 120. (Step 700)

Upon the hosting provider 140 determining the hosting business geo-location does not match and does not overlap the website visitor geo-location or the hosting provider 140 determining the hosting business industry does not match and does not overlap the website visitor industry, the hosting provider 140 may not display the advertisement 151, 161 on the second website to the website visitor 120. (Step 710)

Machine learning, artificial intelligence, smart computer algorithms or any other desired method may be used by the hosting provider 140 to automatically, programmatically and without human intervention quickly and efficiently compare a website visitor geo-location and a website visitor industry to an advertisement geo-location and an advertisement industry respectively to determine matches and/or overlaps. A direct one to one comparison is not always needed as possible geo-locations (for the website visitor and the advertisement) and/or possible industries (for the website visitor and the advertisements) may be stored in a database and organized into categories, nested categories, tree directories, hierarchical structure or other ranking systems that may be used to make the determination of whether or not a website visitor geo-location and a website visitor industry match and/or overlap with an advertisement geo-location and an advertisement industry respectively.

As a non-limiting example, an industry of a “restaurant” overlaps an industry of an “American restaurant” and an industry of an “Italian restaurant” and the industry of the “Italian restaurant” overlaps an industry of a “pizza restaurant.” As another non-limiting example, an industry of a “clothing store” overlaps an industry of a “hat store” and an industry of a “shoe store” and the industry of the “shoe store” overlaps an industry of an “athletic shoe store” and an industry of a “dress shoe store.” As another non-limiting example, a geo-location of the “world” overlaps a geo-location of “France” and the geo-location of the “United States” and the geo-location of the “United States” overlaps a geo-location of “Arizona.”

Upon the hosting provider 140 receiving a click on the advertisement on the second website from the website visitor 120, the website visitor 120 may be directed to the first website. The hosting provider 140 may thus receive the website visitor 120 on the first website after the website visitor selects the advertisement 151, 161. The website visitor may then purchase goods and/or services offered by the hosting customer on the first website.

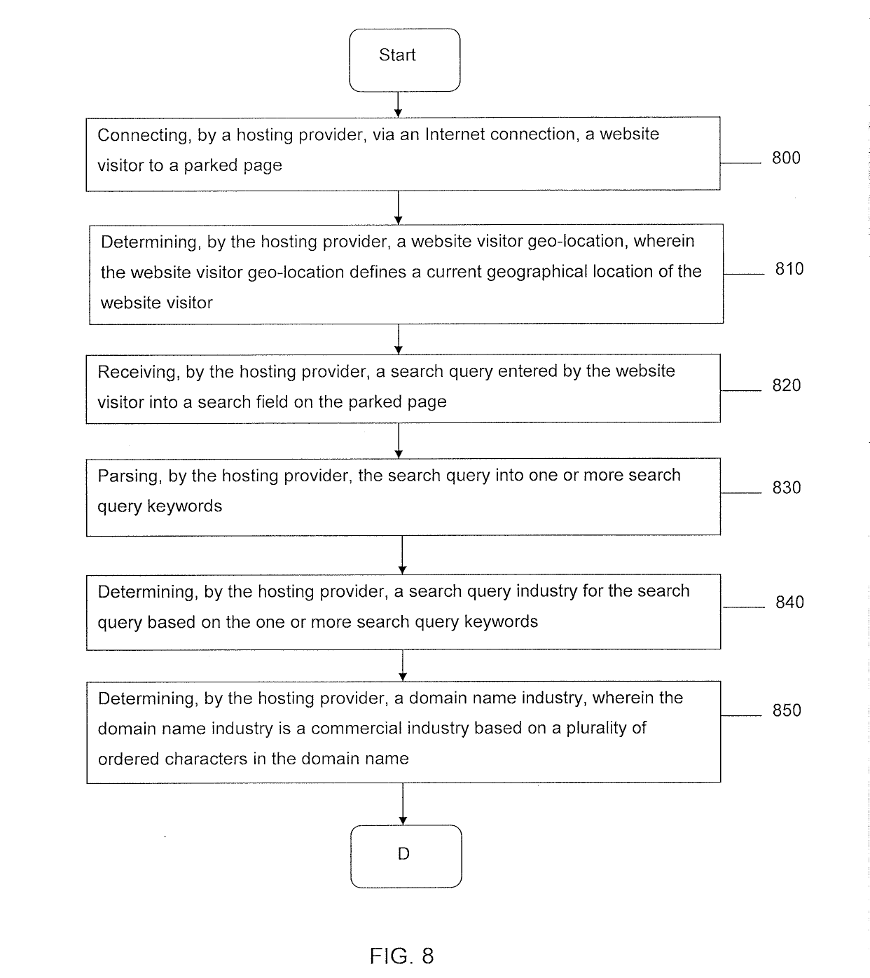

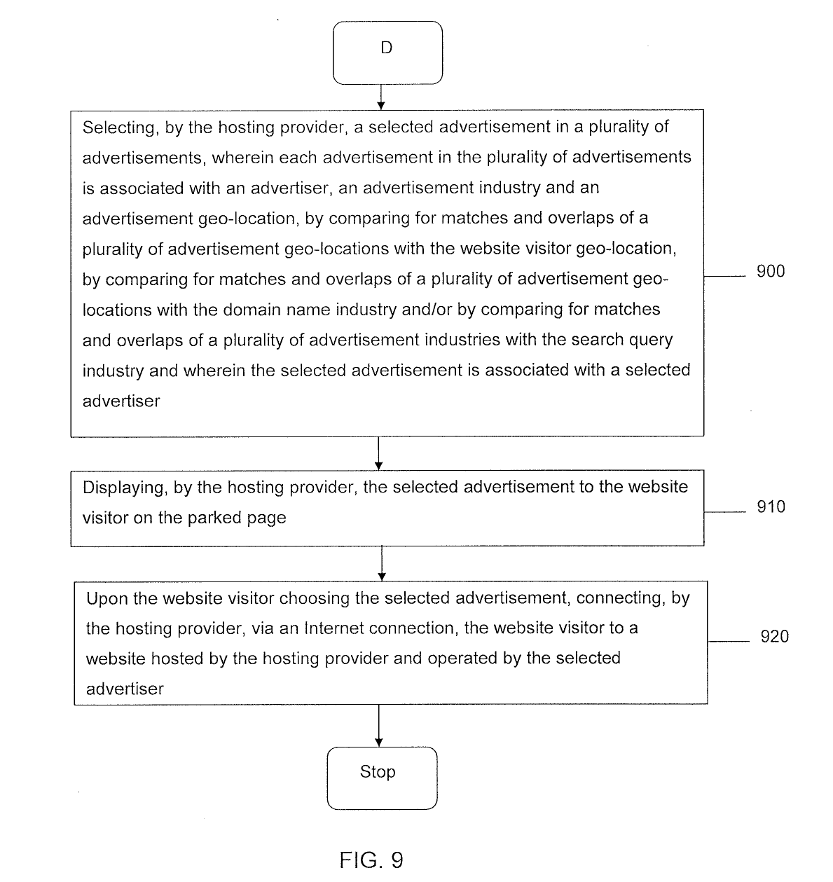

Another embodiment is illustrated in FIGS. 8 and 9. A hosting provider 140 may connect, via an Internet connection, a website visitor 120 to a parked page. In preferred embodiments, the parked page may be pointed to by a domain name registered to a domain name registrant that is not making active use of the domain name. This may allow the registrant to receive advertising fees for the domain name even though the domain name is not being used by the registrant. (Step 800) The parked page may be represented by the websites 150, 160 illustrated in FIGS. 1 and 2.

The hosting provider 140 may determine a website visitor geo-location. The website geo-location may be the current location of the website visitor 120. The website visitor geo-location may be determined from an IP address received by the hosting provider 140 and comparing the IP address to a list of known geo-graphic locations for IP addresses or the website visitor geo-location may be determined based on a GPS location communicated from a client device used by the website visitor 120. (Step 810)

The hosting provider 140 may receive a search query entered by the website visitor 120 into a search field on the parked page. (Step 820) The hosting provider 140 may parse the search query into one or more search query keywords. (Step 830) The hosting provider 140 may determine a search query industry for the search query based on the one or more search query keywords. (Step 840) The hosting provider may compare the one or more search query keywords with words that are known to be associated with a particular industry. If one or more of the search query keywords match a word known to be associated with a particular industry or if one or more of the search query keywords directly matches the name of a particular industry, the search query industry may be assigned or determined as that industry.

The hosting provider 140 may determine a domain name industry for a domain name that points to the parked page, i.e., websites 150, 160. (Step 850) The domain name industry may be a commercial industry determined from a plurality of ordered characters in the domain name. As a non-limiting example, the domain name may be parsed into one or more domain name keywords. The hosting provider may compare the domain name keywords with a plurality of words, where each word is known to be associated with one or more industry. If at least one of the one or more domain name keywords match a word known to be associated with a particular industry or if one or more of the domain name keywords directly matches the name of a particular industry, the domain name industry may be assigned or determined as the industry with associated words that match the domain name keywords.

The hosting provider 140 may receive a plurality of advertisements from a plurality of advertisers, with each advertisement in the plurality of advertisements being associated with an advertisement geo-location, an advertisement industry and an advertiser. Advertisers may have a website hosted with the hosting provider 140 and/or the advertisers may have a website hosted by a different hosting provider. The hosting provider 140 may compare any desired factor(s) in selecting one or more advertisements to be displayed to the website visitor 120 on the parked page. (Step 900) As non-limiting examples, the hosting provider 140 may determine matches and overlaps of a plurality of advertisement geo-locations with the website visitor geo-location, determine matches and overlaps of a plurality of advertisement industries with the domain name industry and/or determine matches and overlaps of a plurality of advertisement industries with the search query industry. Other factors, such as giving preference to paid advertisements over nonpaid advertisements, giving preference to advertisements that have not been seen as recently as other advertisements, giving preference to advertisements from hosting customers of the hosting provider 140 and/or other factors may be used in selecting one or more advertisements to be displayed on the parked page or website 150, 160 to the website visitor 120.

Advertisements with an advertiser geo-location that matches or overlaps the website visitor geo-location are preferred in the selection process over advertisements with an advertiser geo-location that does not match or overlap the website visitor geo-location.

Advertisements with an advertiser industry that matches or overlaps the domain name industry and/or the search query industry are preferred in the selection process over advertisements with an advertiser industry that that does not match or overlap the domain name industry and/or the search query industry.

The hosting provider 140 may display one or more selected advertisements to the website visitor 120 on the parked page. (Step 910)

Upon the website visitor 120 choosing a selected advertisement, the website visitor 120 may be connected by the hosting provider, via an Internet connection, to a website operated by the selected advertiser. In preferred embodiments, the selected advertiser operates a website hosted by the hosting provider, although the selected advertiser may operate a website hosted by a different hosting provider. (Step 920)

Advertisement revenue may be disbursed to domain name registrants for the use of their domain names. In preferred embodiments, the more advertisements selected on a parked page or website 150, 160 pointed to by a domain name, the more advertisement revenue is disbursed to the registrant of the domain name. Additional revenue may be disbursed to the domain name registrant based on the goods or services purchased by the website visitor 120 on a website operated by the selected advertiser. This permits a domain name registrant to generate revenue for domain names that are not being actively used (are not pointed to a website operated by the domain name registrant) by the domain name registrant.

While only one hosting customer was described, any number of hosting customers may submit advertisements that may be displayed to website visitors. While only one website visitor 120 was described, any number of website visitors may visit one or more websites (which may be parked pages) to see one or more advertisements 151, 161. While only a website visitor geo-location and a hosting business geo-location and a website visitor industry and a hosting business industry were compared, any number of other factors may be compared and used in selecting one or more advertisements 151, 161 to be displayed to the website visitor 120 on the second website. It should be noted that domain name registrars are able to register domain names to domain name registrants and are also able to perform other functions as herein described. Likewise, hosting providers are able to host websites that are accessible by the Internet and are also able to perform other functions as herein described.

All processes and methods described herein, unless specifically stated otherwise, are hereby defined to be done automatically and without human intervention. This may be accomplished by programmatically performing all processes and methods described herein on one or more hardware servers that comprise electrical and mechanical components and computer software. While the hardware servers may run the computer software, the hardware servers are physical electrical mechanical devices and are not just or only computer software.

Other embodiments and uses of the above inventions will be apparent to those having ordinary skill in the art upon consideration of the specification and practice of the invention disclosed herein. The specification, abstract and examples given should be considered exemplary only, and it is contemplated that the appended claims will cover any other such embodiments or modifications as fall within the true scope of the invention.

The invention claimed is:

1. A method, comprising the steps of:
connecting, by a hosting provider, via an Internet connection, a website visitor to a parked page;
determining, by the hosting provider, a website visitor geo-location, wherein the website visitor geo-location defines a current geographical location of the website visitor;
receiving, by the hosting provider, a signal encoding a search query entered by the website visitor into a search field user interface element on the parked page;
parsing, by the hosting provider, the search query into one or more search query keywords;
determining, by the hosting provider, a search query industry for the search query based on the one or more search query keywords;
accessing, by the hosting provider, a database storing a plurality of advertisements, wherein each advertisement in the plurality of advertisements is associated with an advertiser, an advertisement industry and an advertisement geo-location, to identify a selected advertisement in a plurality of advertisements by:
identifying matches and overlaps of a plurality of advertisement geo-locations with the website visitor geo-location, and
identifying matches and overlaps of a plurality of advertisement industries with the search query industry, wherein the selected advertisement is associated with a selected advertiser;
incorporating, by the hosting provider, the selected advertisement into a display element on the website for display to the website visitor; and
upon the website visitor activating the selected advertisement, transmitting a redirect message, by the hosting provider, via an Internet connection, to the website visitor to cause a website browser of the website visitor to access a website hosted by the hosting provider and operated by the selected advertiser.

2. The method of claim 1, further comprising the step of:
receiving, by the hosting provider, from the selected advertiser in a hosting account with the hosting provider the advertisement geo-location of the selected advertisement and the advertisement industry of the selected advertisement.

3. The method of claim 1, wherein the step of selecting, by the hosting provider, a selected advertisement includes giving a preference to one or more advertisements in the plurality of advertisements associated with one or more advertisers with a website hosted by the hosting provider over one or more advertisements in the plurality of advertisements associated with one or more advertisers without a website hosted by the hosting provider.

4. The method of claim 1, wherein the step of selecting, by the hosting provider, a selected advertisement includes giving a preference to a first one or more advertisements in the plurality of advertisements that have not been displayed as recently as a second one or more advertisements in the plurality of advertisements.

5. The method of claim 1, wherein the step of selecting, by the hosting provider, a selected advertisement includes giving a preference to a first one or more advertisements in the plurality of advertisements with a higher paid advertisement fee over a second one or more advertisements in the plurality of advertisements.

6. A method, comprising the steps of:
connecting, by a hosting provider, via an Internet connection, a website visitor to a parked page, wherein the parked page is pointed to by a domain name;
determining, by the hosting provider, a website visitor geo-location, wherein the website visitor geo-location defines a current geographical location of the website visitor;
determining, by the hosting provider, a domain name industry, wherein the domain name industry is a commercial industry based on a plurality of ordered characters in the domain name;
selecting, by the hosting provider, a selected advertisement in a plurality of advertisements, wherein each advertisement in the plurality of advertisements is associated with an advertiser, an advertisement industry and an advertisement geo-location by:
comparing for matches and overlaps of a plurality of advertisement geo-locations with the website visitor geo-location, and
comparing for matches and overlaps of a plurality of advertisement industries with the domain name industry, wherein the selected advertisement is associated with a selected advertiser;
displaying, by the hosting provider, the selected advertisement to the website visitor on the parked page; and
upon the website visitor choosing the selected advertisement, connecting, by the hosting provider, via an Internet connection, the website visitor to a website hosted by the hosting provider and operated by the selected advertiser.

7. The method of claim 6, further comprising the step of:
receiving, by the hosting provider, from the selected advertiser in a hosting account with the hosting provider the advertisement geo-location of the selected advertisement and the advertisement industry of the selected advertisement.

8. The method of claim 6, wherein the step of selecting, by the hosting provider, a selected advertisement includes giving a preference to one or more advertisements in the plurality of advertisements associated with one or more advertisers with a website hosted by the hosting provider over one or more advertisements in the plurality of advertisements associated with one or more advertisers without a hosted website hosted by the hosting provider.

9. The method of claim 6, wherein the step of selecting, by the hosting provider, a selected advertisement includes giving a preference to a first one or more advertisements in the plurality of advertisements that have not been displayed as recently as a second one or more advertisements in the plurality of advertisements.

10. The method of claim 6, wherein the step of selecting, by the hosting provider, a selected advertisement includes giving a preference to a first one or more advertisements in the plurality of advertisements with a higher paid advertisement fee over a second one or more advertisements in the plurality of advertisements.

11. The method of claim 6, wherein the step of determining, by the hosting provider, the domain name industry includes the steps of:
parsing the domain name into one or more domain name keywords;
matching at least one of the one or more domain name keywords with a word known to be associated with a first commercial industry; and
assigning the first commercial industry to the domain name industry.

12. A method, comprising the steps of:
connecting, by a hosting provider, via an Internet connection, a website visitor to a website, wherein the website is pointed to by a domain name;
determining, by the hosting provider, a website visitor geo-location, wherein the website visitor geo-location defines a current geographical location of the website visitor;
receiving, by the hosting provider, a search query entered by the website visitor into a search field on the website;
parsing, by the hosting provider, the search query into one or more search query keywords;
determining, by the hosting provider, a search query industry for the search query based on the one or more search query keywords;
selecting, by the hosting provider, a selected advertisement in a plurality of advertisements, wherein each advertisement in the plurality of advertisements is associated with an advertiser, an advertisement industry and an advertisement geo-location, by comparing for matches and overlaps of a plurality of advertisement geo-locations with the website visitor geo-location and by comparing for matches and overlaps of a plurality of advertisement industries with the search query industry and wherein the selected advertisement is associated with a selected advertiser;
displaying, by the hosting provider, the selected advertisement to the website visitor on the website.

13. The method of claim 12, wherein the website is a parked page.

14. The method of claim 12, wherein the step of determining, by the hosting provider, the website visitor geo-location step includes comparing an IP address, received by the hosting provider when connecting the website visitor to the website, with a list of known locations for all IP addresses.

15. The method of claim 12, wherein the determining, by the hosting provider, the website visitor geo-location step includes receiving a GPS location from a client device used by the website visitor.

16. A method, comprising the steps of:
connecting, by a hosting provider, via an Internet connection, a website visitor to a website, wherein the website is pointed to by a domain name;
determining, by the hosting provider, a website visitor geo-location, wherein the website visitor geo-location defines a current geographical location of the website visitor;
determining, by the hosting provider, a domain name industry, wherein the domain name industry is a commercial industry based on a plurality of ordered characters in the domain name;
selecting, by the hosting provider, a selected advertisement in a plurality of advertisements, wherein each advertisement in the plurality of advertisements is associated with an advertiser, an advertisement industry and an advertisement geo-location by:
comparing for matches and overlaps of a plurality of advertisement geo-locations with the website visitor geo-location, and
comparing for matches and overlaps of a plurality of advertisement industries with the domain name industry, wherein the selected advertisement is associated with a selected advertiser; and
displaying, by the hosting provider, the selected advertisement to the website visitor on the website.

17. The method of claim 16, wherein the website is a parked page.

18. The method of claim 16, wherein the step of determining, by the hosting provider, the domain name industry includes the steps of:
parsing the domain name into one or more domain name keywords;
matching at least one of the one or more domain name keywords to a word known to be associated with a first commercial industry; and
assigning the domain name industry to the first commercial industry.

19. The method of claim 16, wherein the step of determining, by the hosting provider, the website visitor geo-location step includes comparing an IP address, received by the hosting provider when connecting the website visitor to the website, with a list of known locations for all IP addresses.

20. The method of claim 16, wherein the determining, by the hosting provider, the website visitor geo-location step includes receiving a GPS location from a client device used by the website visitor.
